(19) United States
(12) Patent Application Publication
(10) Pub. No.: US 2009/0120816 A1
(43) Pub. Date: May 14, 2009

(54) Sustainability in personal care product packaging

(76) Inventors: Marcille Faye Ruman, Oshkosh, WI (US); Louise Cynthia Ellis Coe, Appleton, WI (US); Heidi Lynn Carey, Neenah, WI (US); Jason Robert Boon, Appleton, WI (US); Christian Matthew Hirthe, Appleton, WI (US); Heidi Bauerlein Hopkins, Neenah, WI (US); Jason Daniel Rottier, Appleton, WI (US); Margaret Mary Posorske, Oshkosh, WI (US); Charlcie Christie Kay Leitner, Appleton, WI (US); Paula Mary Sosalla, Appleton, WI (US)

Correspondence Address: KIMBERLY-CLARK WORLDWIDE, INC.;Catherine E. Wolf, 401 NORTH LAKE STREET, NEENAH, WI, 54956, US

(21) Appl. No.: 11/983,853

(22) Filed: Nov. 13, 2007

(51) Int. Cl. A45D 33/26; A61J 1/00; B65D 25/08; B65D 77/04; B65D 77/28; B65D 45/16; B65D 25/30

(52) U.S. Cl. 206/232; 206/438; 206/459.5; 220/529; 206/216; 220/324; 220/755

(57) ABSTRACT

Packaging is provided in which to supply disposable personal care products to a consumer, wherein at least a portion of the packaging is adapted to be reused by the consumer. The packaging includes a storage bin having a storage bin bottom and a reclosable cover and defining an interior space and a vertical perimeter, a removable bin enclosure disposed to encircle a portion of the vertical perimeter, wherein the bin enclosure includes product-identifying graphics, and an inner package disposed in the interior space, the inner package including a plurality of disposable personal care products. The removable bin enclosure can be a removable sleeve adapted to secure the reclosable cover to the storage bin bottom. The removable bin enclosure can also be a film overwrap, and the inner package and overwrap can be biodegradable.

### BACKGROUND

Personal care products such as toiletries, moist and dry wipes, diapers, training pants, incontinence products, feminine hygiene products, swim undergarments, and the like, are conventionally packaged in discardable packaging, including significant portions that are not or cannot be recycled.

Manufacturers, retailers, and consumers of personal care products recognize a need to address environmental concerns. One slogan used to promote environmental awareness and sustainability is reduce, reuse, and recycle. Current personal care product packaging schemes, however, cannot meet these goals. An opportunity exists to create-extended use packaging to help meet these goals.

### SUMMARY

The goals of reducing, recycling, and reusing can be accomplished in packaging used to deliver products to a consumer by reducing the amount of packaging for a given product, making the packaging useful and appealing enough to promote their reuse, and by using packaging materials that are recyclable. The present disclosure describes packaging that can accomplish these goals.

The present inventors undertook intensive research and development efforts concerning improving the delivery of personal care products, particularly with respect to providing packaging that can be recycled and/or reused. The packaging not only serves to contain and identify personal care products for shipping and retail purposes, but converts the packaging into another use that is tested to be highly desired by the consumer. The disclosure presented herein demonstrates personal care product packaging in the form of a reusable storage bin. After emptying the personal care product contents, a consumer can use the handy, stackable storage bins, thus extending the packaging usefulness to the consumer.

Packaging is provided in which to supply disposable personal care products to a consumer, wherein at least a portion of the packaging is adapted to be reused by the consumer. The packaging includes a storage bin having a storage bin bottom and a reclosable cover and defining an interior space and a vertical perimeter, a removable bin enclosure disposed to encircle a portion of the vertical perimeter, wherein the bin enclosure includes product-identifying graphics, and an inner package disposed in the interior space, the inner package including a plurality of disposable personal care products. The removable bin enclosure can be a removable sleeve adapted to secure the reclosable cover to the storage bin bottom. The removable bin enclosure can also be a film overwrap, and the inner package and overwrap can be biodegradable.

### BRIEF DESCRIPTION OF THE DRAWINGS

The foregoing and other features and aspects of the present disclosure and the manner of attaining them will become more apparent, and the disclosure itself will be better understood by reference to the following description, appended claims, and accompanying drawing.

FIG. 1 is a partially-cutaway perspective view of one aspect of a storage bin.

Repeat use of reference characters in the present specification and drawing is intended to represent the same or analogous features or elements of the present disclosure.

### DETAILED DESCRIPTION

It is to be understood by one of ordinary skill in the art that the present discussion is a description of exemplary aspects only, and is not intended as limiting the broader aspects of the present disclosure.

The present disclosure is generally directed to personal care products and how they are packaged for transport and retail sale. The personal care product can be, for instance, a moist or dry wipe, a toiletry, or an absorbent article such as a diaper, a training pant, an incontinence product, a feminine hygiene product, a medical garment, a bandage, or the like. Generally, the personal care products are disposable, meaning that they are designed to be discarded after a limited use rather than being laundered or otherwise restored for reuse.

Manufacturers, retailers, and consumers of personal care products recognize a need to address environmental concerns. One slogan used to promote environmental awareness and sustainability is reduce, reuse, and recycle. These goals can be accomplished in packaging used to deliver products to a consumer by reducing the amount of packaging for a given product, making the packaging useful and appealing enough to promote their reuse, and by using packaging materials that are recyclable. The present disclosure describes packaging that can accomplish these goals.

The packaging described herein is a value added and retailer-differentiated solution. The packaging is unique in that it includes attractive graphics and branding to convey that the storage bin is an easy-organizing extra for the customer, shopper, and/or user, and is worth a higher price per personal care product. The storage bin itself carries minimal to no information. Instead, a removable bin enclosure communicates all of the manufacturing, distribution, branding, and labeling requirements. A package violator can communicate product claims with respect to reusable storage, stylish design, and environmental sustainability.

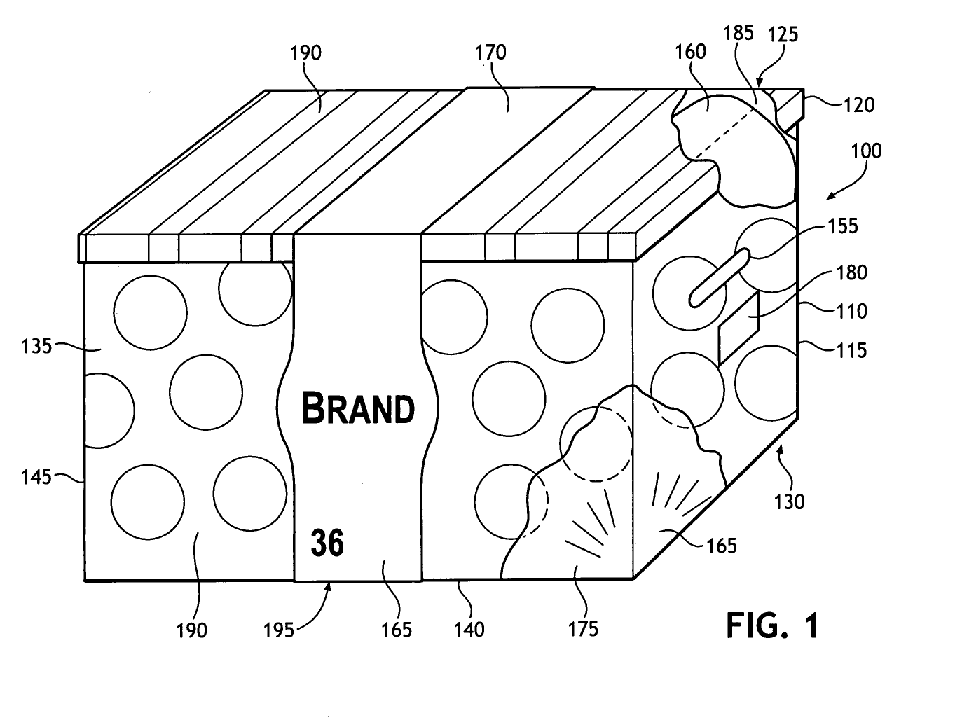

The packaging described herein is particularly useful for transporting and selling disposable personal care products including absorbent articles, wipes, toiletries, and other personal health and hygiene items. Referring to FIG. 1 for exemplary purposes, a packaging system 100 is shown. The packaging system 100 is adapted such that all or most of the packaging system 100 is readily reused and/or recycled. The packaging system 100 described herein increases the likelihood a consumer will select more environmentally sustainable packaging for disposable personal care products, thus eliminating the need for standard packaging.

As illustrated in FIG. 1, the packaging system 100 includes a storage bin 110 as its central component. The storage bin 110 includes a storage bin bottom 115 and a cover 120. The cover 120 is either partially or completely removable from the storage bin bottom 115, and is capable of being reattached to or re-set upon the storage bin bottom 115 to reclose the storage bin 110. In other aspects, the cover 120 can be in the form of a single or multiple flaps. The storage bin bottom 115 and cover 120 together define an interior space 125 of the storage bin 110.

The storage bin 110 as illustrated is generally rectilinear, but can be any suitable shape. The storage bin bottom 115 includes a lower face 130 and, if rectilinear, also includes four sides. If, for example, the storage bin 110 is generally cylindrical, the storage bin bottom 115 will include only one side 135 extending around the perimeter of the lower face 130. The storage bin 110 has a footprint, which is generally the view of the lower face 130 either from below or from the interior space 125. If the storage bin 110 is rectilinear, then the footprint will be rectilinear as well. If the storage bin 110 is cylindrical, then the footprint will be circular. The footprint can be any other suitable shape including an oval, a hemisphere, a triangle, a square, or any other shape including linear and/or arcuate portions.

The storage bin 110 also defines a horizontal perimeter 140 and a vertical perimeter 145. The horizontal perimeter 140 is generally the distance around the storage bin 110 on a horizontal plane, such as the perimeter of the lower face 130. The vertical perimeter 145 is generally the distance around the storage bin 110 on a vertical plane, such as across the cover 120, across the lower face 130, and across two opposed sides 135.

The storage bin 110 can be manufactured from any suitable material including corrugated cardboard, injection-molded or other plastic, wood, woven or nonwoven fabrics, or combinations of these. As a result, the storage bin 110 can be rigid or flexible, or a combination of these. Part or all of the storage bin 110 can be opaque, translucent, or generally transparent, and can be of any suitable color. In one example, the storage bin 110 can be manufactured from corrugate sturdy enough to support reuse of the storage bin 110 by the consumer. In another example, the storage bin 110 can be manufactured from multi-layered, insulated, liquid-resistant fabric such that a consumer can reuse the storage bin 110 as a cooler. In still another example, the storage bin 110 can be manufactured from plastic such that the consumer can reuse the storage bin 110 for semi-permanent storage, as a planter, or for any other typical household use.

Packaging used prior to this invention is optimized to minimize material usage; it is designed to be only durable enough to get products to a consumer. As a result, current packaging is not durable and has limited reuse possibilities. Packaging of the present disclosure is made to be more durable and thus have uses beyond shipping and retailing purposes. The storage bin 110 can also feature a label area, a removable cover 120, etc. Consumers want ready-to-use packaging; they do not want to assemble a storage bin 110 or a cover 120, and they want easy access to the packaging and product.

There are many storage bin styles including but not limited to, slotted boxes, telescoping boxes, folders, rigid boxes such as Bliss boxes, self-erecting boxes, corrugated common footprint containers, and interior forms. Interior forms such as liners, tubes, pads, build-ups, dividers, partitions, and other inner packaging pieces can be made in an infinite variety of ways to separate or cushion products, to strengthen the storage bin 110, or to fill voids to prevent products from moving.

In the aspects of the present disclosure in which the storage bin 110 is made from corrugate, a consumer-preferred version of a reusable storage bin 110 is a half-slotted storage bin 110 and a tray as the cover 120. Half-slotted means that the storage bin 110 has no top flaps. Interior forms may be added to the storage bin 110 to improve storage bin durability and/or to increase functionality and reusability of the storage bin 110. A Bliss box, which has no bottom flaps and which is similar to a standard shoe box, is also very appealing to consumers because it eliminates gaps and the potential for the bottom to break open.

Also, in the aspects of the present disclosure in which the storage bin 110 is made from corrugate, corrugated fiberboard, or combined board, has two main components: the linerboard and the medium. Both are made of a special kind of heavy paper called container board. Linerboard is the flat facing or liner that adheres to the medium. The medium is the corrugated or fluted paper glued between the linerboard facings. Linerboard can be single face, single wall, double wall, or triple wall. Flutes come in several common sizes or profiles ranging from A (33 flutes/foot) to F (125 flutes/foot). Smaller flute profiles provide enhanced structural and graphics capability for primary and retail packaging, while larger flute profiles deliver a greater vertical compression strength and cushioning. Different flute profiles can be combined in one piece of combined board. Mixing flute profiles allows designers to manipulate the compression strength and total thickness of the combined board.

For storage bins 110 of the present disclosure, a consumer-preferred version of a reusable storage bin 110 is a single- or double-wall structure depending on the substrates (e.g., materials, weight, flute) used. This is done to minimize the storage bin's vulnerability to crushing, abrasion, and puncturing. Consumers desire high-quality graphics on a strong and durable storage bin 110. Retail diaper and wipes boxes commonly use B or C flutes to balance aesthetic and structural requirements. In double wall containers, varied flute profiles provide advantages over flutes of the same size that are perfectly aligned. Smaller and finer fluting is desired on the outside of the storage bin to maintain high quality graphics.

Corrugating adhesive is normally bonded to the liners with a starch-based adhesive. It is available in several levels of water resistance. A flat piece of corrugated fiberboard that has been cut, slotted, and scored is called a box blank. For some box styles, in order to make a box, the two ends of the box blank must be fastened together with glue, tape, or staples. The place where these two ends meet is known as the manufacturer's joint. For storage bins 110 of the present disclosure, a glue joint on the inside of the storage bin 110 is preferred. This is done for both aesthetics and safety reasons. Also, for the storage bin 110 and cover 120 in general, it is desired to have the entire structure glued versus taped or stapled.

Accurate inside storage bin dimensions must be determined to ensure the proper fit of the products being shipped or stored. In addition, accurate outside storage bin dimensions must be determined to optimize palletizing and distributing the product. For storage bins 110 of the present disclosure, storage bin dimensions are influenced by several factors including: consumer-preferred storage bin dimensions, retailer-desired price point of offering, product quantity, product size and configuration (e.g., arrangement and orientation), pallet footprint and cube utilization, and manufacturing equipment limitations.

In other aspects of the present disclosure, windows or special cut outs can be added to the storage bin 110 to enhance functionality or aesthetic appeal, including to add air vents to the storage bin 110. In still other aspects of the present disclosure, the storage bin 110 can include a second storage bin 110 inside for strength.

The cover 120 can include a latching element (not shown) to allow the cover 120 to be positively attached to the storage bin bottom 115. The latching element can be any suitable mechanism, including adhesives, rigid or flexible tabs that engage a slot or other device, elements to allow the cover 120 to be snapped onto the storage bin bottom 115, a simple friction fit, hardware such as hinges and hasps, or any combination of these. The cover 120 can have an indentation sized to the outline of the lower face 130 of another storage bin 110 to assist in positioning and to provide stability while stacking storage bins 110.

The storage bin 110 can also include at least one hand hold 155 adapted to accommodate at least a portion of a human hand to facilitate grasping the storage bin 110. The hand hold 155 can be positioned on any side, on the lower face 130, or on the cover 120. The storage bin 110 can alternatively include a plurality of hand holds 155 positioned on any or all of those locations. The hand hold 155 can be a hole in the storage bin 110. The hand hold 155 can also be a handle or any other suitable device adapted to accomplish the purpose of grasping the storage bin 110.

The features selected for the storage bin 110 are selected to be representative of the reuse of the storage bin 110. Such features include the hand holds 155 and the cover 120, along with other features described herein. Such features ensure that the storage bin 110 functions properly during reuse.

The storage bin 110 as it is presented to the consumer includes disposable personal care products within the interior space 125 of the storage bin 110. Such disposable personal care products include, but are not limited to, absorbent articles, dry, moist, or wet wipes, toiletries, and other personal care items. Absorbent articles include diapers, training pants, swim pants, incontinence products, feminine hygiene products, bandages, and the like. The personal care products can be disposed within the interior space 125 in any suitable arrangement.

In another aspect of the present disclosure, the personal care products can be disposed within one or more inner packages 160. Such inner packages 160 can provide compression, containment, environmental protection, and/or organization to the personal care products. In one aspect, the inner package 160 is a flexible consumer package, which refers to non-rigid containers, such as polyethylene bags, that are adapted to contain personal care products and are adapted to be presented to a consumer. In other various aspects, the inner package 160 is manufactured from standard poly film, paper, woven or nonwoven fabric, or from any other suitable material or combination of materials and in any suitable manner. In another aspect of promoting reuse of the inner package 160, the inner package 160 includes a reclosing element that allows the inner package to be reclosed after it has been opened. Such a reclosing element can be a zipper-type closure or any other suitable closure element. In another aspect, the reclosing element can make the inner package 160 airtight. The inner package 160 can also be designed to provide resistance to mildew, insects, odors, dust, mold, and/or other undesirable factors by suitable and known means. In still another aspect, the inner package 160 can be adapted to be a vacuum-type package to help exclude such undesirable factors. The consumer can squeeze the air out of the inner package 160 and then seal the inner package 160 with an airtight reclosing element. Alternately, the inner package 160 can be provided with a one-way or check valve to allow air to escape the inner package 160 when squeezed, while at the same time excluding re-entry of air. The inner package 160 can also include a vacuum cleaner adapter to allow the consumer to use a vacuum cleaner to remove air from the inner package 160.

In other aspects of the present invention, the inner package 160 can be a paper bag or other recyclable, minimalistic packaging. The inner package 160 can also be a basket or tray to dispense product that can, for example, assist with the diapering experience. The inner package 160 can also be a reusable caddy or bag with handles that can also assist with the diapering experience. The inner package 160 can also be a non-woven or cloth-like bag that can be reused for baby care and diapering on the go. The inner package 160 can also be a diaper disposal bag that can assist with the diapering experience. Finally, the inner package 160 can also be a waterproof mildew-resistant bag that can be reused for storage. The inner package 160 can be clear, semitransparent, opaque, or have stylish graphics (with or without branding) to blend with home and baby decor and/or mom's and baby's wardrobe and accessories.

In other aspects of the present invention, the inner package 160 can be a box, bottle, or other suitable container, particularly if the personal care product is a moist wipe or a toiletry such as a shampoo. In still other aspects of the present disclosure, the inner package 160 can be any suitable structure conducive to being reused including, but not limited to, a tote bag, a lingerie bag, a laundry bag, a trash bag, a box, a bottle, a cooler, a gym bag, a purse, a duffel bag, or a second storage bin 110 smaller than the storage bin 110 in which it is disposed. Such aspects ensure secondary usefulness and appeal of the inner package 160, and therefore of the storage bin 110.

The packaging system 100 can also include a bin enclosure 165 that partially or completely envelops the storage bin 110. The bin enclosure 165 can assist in ensuring the cover 120 stays in place atop the storage bin bottom 115 through manufacturing, shipping, and retail handling. The bin enclosure 165 can also provide space on which to provide product, brand, and other labeling information. The bin enclosure 165 can also provide environmental protection to shield the storage bin 110 from dust, dirt, water, and other hazards that might otherwise adversely affect the appearance, performance, and value of the storage bin 110 and the products within.

In one aspect of the present disclosure, the bin enclosure 165 is a sleeve 170 that surrounds all or part of the vertical perimeter 145 of the storage bin 110. In general, the sleeve 170 encircles the storage bin 110 to provide both a means of keeping the cover 120 in place atop the storage bin bottom 115 and an additional surface on which to provide product, brand, and other labeling information. The sleeve 170 has a bin-facing side and an outward-facing side. The sleeve 170 can be manufactured from paperboard, poly film, woven or nonwoven fabric, or any other suitable material or combination of materials. The sleeve 170 is wrapped around the storage bin 110 and then attached to itself and/or the storage bin 110 using adhesives, tabs, or any other suitable mechanisms. The sleeve 170 can be centered on the storage bin 110 or can be offset toward one side of the storage bin 110. In other aspects of the present disclosure, windows or special cut outs can be added to the sleeve 170 to enhance functionality or aesthetic appeal.

Various aspects on the present disclosure make the sleeve 170 conducive to be reused. In one of these aspects, the sleeve 170 can be a cuboid with one open face and sized such that the sleeve 170 can be placed over one end of the storage bin 110 to encompass one side, parts of two other sides, part of the cover 120, and part of the lower face 130 of the storage bin 110. In this aspect, the sleeve 170, once removed from the storage bin 110, can be used as a wastebasket or as an additional storage bin 110. In this aspect, the sleeve 170 can also include a sleeve cover that is folded under the sleeve 170 when the sleeve 170 is disposed on the storage bin 110, but that is easily unfolded once the sleeve 170 is removed from the storage bin 110.

In another aspect of the present disclosure for promoting reuse of the sleeve 170, the sleeve 170 is reversible and adapted to be used to secure the cover 120 on the storage bin 110 during use of the storage bin 110. The sleeve 170 can be provided with adhesives, tabs, or any other mechanism suitable for a consumer to reverse the sleeve 170 and re-attach the sleeve 170 to itself or to the storage bin 110 to allow reuse of the sleeve 170. In this aspect, the bin-facing side of the sleeve 170 typically has a color and/or pattern printed or otherwise disposed thereon.

In another aspect of the present disclosure, the bin enclosure 165 is an overwrap 175 that surrounds all or part of the storage bin 110. In general, the overwrap 175 encloses the storage bin 110 to provide a means of keeping the cover 120 in place atop the storage bin bottom 115; an additional surface on which to provide product, brand, and other labeling information; and environmental protection of storage bin 110 and its contents. The overwrap 175 can be manufactured from poly film, polarizing film, woven or nonwoven fabric, or any other suitable material or combination of materials. The overwrap 175 is wrapped around the storage bin 110 and then attached to itself and/or the storage bin 110 using heat, shrinking, adhesives, tabs, or any other suitable mechanisms.

In an aspect of the present disclosure promoting reuse of the overwrap 175, the overwrap 175 includes a reclosing element that allows the overwrap 175 to be reclosed after it has been opened. Such a reclosing element can be a zipper-type closure or any other suitable closure element.

In general, the bin enclosure 165, whether it is a sleeve 170 or an overwrap 175, can include indicia indicating a secondary use of the bin enclosure 165. In addition, the packaging system 100 can include both a sleeve 170 and an overwrap 175. In this aspect, the sleeve 170 is typically placed directly on the storage bin 110 as a means of keeping the cover 120 in place atop the storage bin bottom 115. The overwrap 175 is then placed to enclose both the storage bin 110 and the sleeve 170 as environmental protection of the storage bin 110 and its contents. In this aspect, either or both of the sleeve 170 and the overwrap 175 can be used as a surface on which to provide product, brand, and other labeling information.

In addition to providing aspects of the present disclosure that make components of the packaging system 100 conducive to reuse, various components of the packaging system 100 can also be made conducive to recycling, biodegradation, and overall eco- or earth-friendliness, as the entire process from design to manufacturing through retail sale and home use is important in determining the impact to the Earth. For example, the overwrap and the inner package can each or both be manufactured from any suitable biofriendly materials including, but not limited to, biodegradable, compostable film made from polylactic acid (PLA), a largely corn-based polymer, biodegradable and compostable cellulose films manufactured from renewable resources including renewable wood-pulp, and biodegradable oriented polypropylene (OPP) film. Biopolymers can be made from plant materials such as starch, cellulose, and lignin. Further, biodegradable polymers such as poly-B-hydroxyalkanoate (PHA), poly-B-valerate (PHV), and poly-B-hydroxybutyrate (PHB) are produced by the actions of genetically-modified microorganisms. Biopolymers can also be synthetic polymers or polymers based on fossil fuels that have additives to promote their biodegradability.

With respect to sustainable practices, reduction is at the head of the Environmental Protection Agency's waste management hierarchy: reduce, reuse, recycle, compost and recover energy. Sustainable practices are being promoted across all segments of the packaged goods supply chain. By implementing sustainable packaging such as reusable storage bins 110, society will generate less waste, use fewer materials, and generate savings in manufacturing, transportation, storage, and disposal/recovery. Specific variables that can be controlled include greenhouse gas emissions emitted during manufacture, the environmental-friendliness of materials, product-to-package ratio, cube utilization, transportation impacts, recycled content, recovery value, renewable energy used, and sustainable innovations.

Diapers and other personal care products are already sold in corrugated boxes that consumers tend to recycle or simply discard, to end up in landfills. Also, consumers buy plastic totes to save and store baby things and other items. Shipping and retailing personal care products in a reusable storage bin 110 accrues a double benefit—recycled or discarded shipping boxes are eliminated, and the need to buy additional storage containers is eliminated as well. Consumer and manufacturer efforts are synchronized in getting personal care products to the consumer in a beautiful and earth-friendly storage bin 110.

Additionally, waste is minimized for the selling unit the and the selling unit can be made from earth-friendly materials, recycled, and/or reused. This holds true for the supplementary packaging used to protect the transportation unit (e.g., fillers, caps, corner posts, stretch wrap). Such efforts minimize materials that are put in landfills and minimize overall energy use. Further, co-packing the products employs people and avoids designing costly equipment that may have a limited lifespan due to the specialized nature of the packaging.

Transportation and warehousing are the most frequent places where damage may occur. Compression can occur with static and dynamic loads. Static loads, such as those induced by stacking in a warehouse, are affected by load, time, humidity (static and cyclic), stack pattern, and pallet type and condition. Dynamic loads, such as those induced in transit, are affected by momentary loading, clamp handling, railcar humping/coupling, and trailer sway. In addition to compression, shock (drop, impact, falls), vibration, puncture, temperature, humidity, pressure, corrosion, energy, contamination, shrink, and time are contributors to damage.

Transport packaging has been historically viewed as a value retainer as opposed to a value adder. This approach is being challenged by increased contributions from transport packaging such as shelf presence, marketing, advertising, and ongoing consumer uses, including product dispensing and disposal.

For the packaging of the present disclosure, numerous precautions have been taken to ensure that the storage bin 110, which is marketed as a product, arrives at the retailer in pristine condition and maintains its integrity with consumer use in the home environment. Storage bins 110 are not shipped inside of other shipping or corrugated boxes. To ensure the integrity of the storage bins 110, several variables are controlled and include double wall corrugate, shrink wrap to prevent rubbing and scuffing and to provide friction between packages while stacked, corner posts to prevent vertical crushing, top and bottom caps and slip sheets to distribute load and protect exposed edges, load securement tools in trucks, proper truck handling such as the use of forklifts only without clamping, pallet utilization above 90 percent, pallet quality such as no broken deck boards, stretch wrapping extended to the bottom of the pallet to prevent unit load shifting, limiting stacks to two-high instead of four-high, and direct shipping from co-packer to retailer distribution centers and stores to prevent additional handling.

In another aspect of the present invention, interior packaging such as another box, forms, fillers, dividers, bags, and/or cartons can be used to strengthen the storage bin 110 and further minimize susceptibility to damage in transit or use. In still another aspect of the present invention, personal care products can be shipped to a co-packer in plain packaging, which the co-packer simply slips into a storage bin 110 to minimize product handling.

A potentially key factor in making components of the packaging system 100 conducive to reuse is the design of those components. For example, a consumer is more likely to reuse the storage bin 110 if the storage bin 110 is sturdy enough to last. Features of the packaging system 100 that enhance its appeal include a cover 120 that stays in place atop the storage bin bottom 115 to keep everything in the storage bin 110 and helps to keep people out. In addition, both the cover 120 and any bin enclosures 165 should be easy for a consumer to remove and should be removable without destroying the storage bin 110 or its usefulness.

Product-identifying graphics 195 can include the type of personal care product disposed in the interior space 125, the size or sizes of personal care products disposed in the interior space 125, and the count, amount, or volume of personal care products disposed in the interior space 125, all as applicable to the type of personal care products. Product-identifying graphics 195 can also include the manufacturer, customer service information, use instructions, patent markings, and any other information typically disposed on a package of personal care products.

Further, to enhance a consumer's interest in reusing the storage bin 110, the storage bin 110 includes non-product-identifying graphics 190. The non-product-identifying graphics 190 on the storage bin 110 can be registered in relation to the storage bin bottom 115. The non-product-identifying graphics 190 on the storage bin 110 can include graphical elements such as labels, hinges, hasps, locks, and other elements to enhance the look of the storage bin 110. The non-product-identifying graphics 190 can further include textured elements such as those that can be supplied by embossing. The graphics can include a label area 180 to allow the consumer to label the storage bin 110.

Still further, the non-product-identifying graphics 190 can include graphical elements designed to make the storage bin 110 resemble a household item. For example, the addition of real or graphical hinges and pulls and coordinating graphics can make the storage bin 110 resemble a chest, a dresser, a cabinet, a toy box, a toy, a wardrobe, a trunk, a jewelry box, or a similar item.

In another aspect of promoting reuse of the packaging system 100, the storage bin 110 defines an interior surface 185, and the interior surface 185 includes non-product-identifying graphics 190.

In yet another aspect of promoting reuse of the storage bin 110, the cover 120 can include non-product-identifying graphics 190 different from and complementary with the non-product-identifying graphics 190 on the storage bin bottom 115. In addition, the non-product-identifying graphics 190 of the cover 120 can be registered in relation to the non-product-identifying graphics 190 of the storage bin bottom 115.

In still another aspect of promoting reuse of the sleeve 170, the sleeve 170 is adapted to be reused as a divider in the storage bin 110. The sleeve 170 can include notches, perforations, scoring, and/or markings to indicate how the sleeve 170 can be cut, folded, or otherwise rearranged to be used within the storage bin 110 as a divider. The sleeve 170 can further include instructions for a consumer with respect to rearranging the sleeve 170 to form a divider. The markings and instructions typically appear on the bin-facing side of the sleeve 170 but can appear on the outward-facing side or on both sides of the sleeve 170.

In another aspect of promoting reuse of the sleeve 170, the sleeve 170 is adapted to be reused as a changing pad. The sleeve 170 can include notches, perforations, scoring, markings, and/or instructions to indicate how the sleeve 170 can be altered if appropriate and used as a changing pad. The markings and instructions typically appear on the bin-facing side of the sleeve 170 but can appear on the outward-facing side or on both sides of the sleeve 170.

In other aspects of the present disclosure of promoting reuse of the sleeve 170, the sleeve 170 can include one or more coupons printed or otherwise disposed thereon. The sleeve 170 can also include information related to products other than those disposed in the storage bin 110. The sleeve 170 can also include one or more game boards, crossword puzzles, or other activities printed or otherwise disposed thereon. The sleeve 170 can also include one or more activities suitable for a child, printed or otherwise disposed thereon. In addition, the sleeve 170 can include a growth chart, sizing information for shoes, sizing information for clothes, sizing information for absorbent articles, and/or other information useful to a caregiver or a child, printed or otherwise disposed thereon. Such coupons, games, information, etc. typically appear on the bin-facing side of the sleeve 170 but can appear on the outward-facing side or on both sides of the sleeve 170.

These and other modifications and variations to the present disclosure can be practiced by those of ordinary skill in the art, without departing from the spirit and scope of the present disclosure, which is more particularly set forth in the appended claims. In addition, it should be understood that aspects of the various aspects can be interchanged both in whole or in part. Furthermore, those of ordinary skill in the art will appreciate that the foregoing description is by way of example only, and is not intended to limit the disclosure so further described in such appended claims.

What is claimed is:

1. Packaging in which to supply disposable personal care products to a consumer, wherein at least a portion of the packaging is adapted to be reused by the consumer, the packaging comprising:
a storage bin having a storage bin bottom and a reclosable cover and defining an interior space and a vertical perimeter;
a removable bin enclosure disposed to encircle a portion of the vertical perimeter, wherein the bin enclosure includes product-identifying graphics; and
an inner package disposed in the interior space, the inner package including a plurality of disposable personal care products.

2. The packaging of claim 1, wherein the bin enclosure is a sleeve.

3. The packaging of claim 2, wherein the bin enclosure further comprises an overwrap enclosing the storage bin and the sleeve, wherein the overwrap is a film.

4. The packaging of claim 2, wherein the sleeve is adapted to be reused as a divider in the storage bin.

5. The packaging of claim 2, wherein the sleeve is adapted to be reused as a changing pad.

6. The packaging of claim 2, wherein the sleeve includes a coupon disposed thereon.

7. The packaging of claim 2, wherein the sleeve includes information related to products other than those disposed in the storage bin.

8. The packaging of claim 2, wherein the sleeve includes a game disposed thereon.

9. The packaging of claim 2, wherein the sleeve includes an activity suitable for a child disposed thereon.

10. The packaging of claim 2, wherein the sleeve is reversible and adapted to be used to secure the cover on the storage bin during use of the storage bin.

11. The packaging of claim 2, wherein the sleeve includes printed thereon at least one of a growth chart, sizing information for shoes, sizing information for clothes, and sizing information for personal care products.

12. The packaging of claim 2, wherein the storage bin has an end, wherein the sleeve is a cuboid with one open face, and wherein the sleeve is sized to fit around the end of the storage bin with the end inserted into the open face of the cuboid.

13. The packaging of claim 1, wherein the bin enclosure is an overwrap enclosing the storage bin, wherein the overwrap is a film.

14. The packaging of claim 1, wherein the bin enclosure is adapted to secure the reclosable cover to the storage bin bottom.

15. The packaging of claim 1, further comprising a plurality of inner packages each including a plurality of personal care products.

16. The packaging of claim 1, wherein the cover is removably attached to the storage bin with a latching element.

17. The packaging of claim 1, the storage bin further comprising sides and at least one hand hold on a side, wherein the hold is sized to accommodate a portion of a human hand.

18. The packaging of claim 1, wherein the inner package includes a reclosing element.

19. The packaging of claim 1, wherein the inner package is a vacuum-type inner package.

20. The packaging of claim 1, wherein the bin enclosure includes indicia indicating a secondary use of the bin enclosure.

21. The packaging of claim 1, wherein the bin enclosure is a sleeve, further comprising an overwrap enclosing the storage bin and the sleeve, wherein the overwrap includes a film made from a biodegradable material.

22. The packaging of claim 1, wherein the inner package includes a film made from a biodegradable material.

23. The packaging of claim 1, wherein the cover is removably attached to the storage bin.

24. Packaging in which to supply disposable personal care products to a consumer, wherein at least a portion of the packaging is adapted to be reused by the consumer, the packaging comprising:
a storage bin having a storage bin bottom, sides, and a reclosable cover and defining an interior space and a vertical perimeter, wherein the storage bin includes at least one hand hold on a side, the hold being sized to accommodate a portion of a human hand;
a removable sleeve disposed to encircle a portion of the vertical perimeter, wherein the sleeve includes product-identifying graphics, wherein the sleeve is adapted to secure the reclosable cover to the storage bin bottom;
an overwrap enclosing the storage bin and the sleeve, wherein the overwrap is a film; and
a plurality of inner package disposed in the interior space, each inner package including a plurality of disposable personal care products.
